(19) United States
(12) Patent Application Publication
(10) Pub. No.: US 2014/0338782 A1
(43) Pub. Date: Nov. 20, 2014

(54) MANUFACTURING METHOD FOR BELLOW PIPES

(71) Applicant: TEKLAS KAUCUK SANAYI VE TICARET A.S., Gebze Kocaeli (TR)

(72) Inventor: Murat Bozkurtlu, Gebze Kocaeli (TR)

(73) Assignee: TEKLAS KAUCUK SANAYI VE TICARET A.S., Gebze Kocaeli (TR)

(21) Appl. No.: 14/362,827

(22) PCT Filed: Dec. 7, 2012
(86) PCT No.: PCT/IB2012/002638

§ 371 Date: Jun. 4, 2014

(30) Foreign Application Priority Data
Dec. 7, 2011 (TR) 2011/12134
Dec. 4, 2012 (TR) 2012/14076

(51) Int. Cl. F16L 9/12; B29C 45/00; B29D 23/18

(52) U.S. Cl. CPC F16L 9/12; B29D 23/18; B29C 45/0055; B29L 2023/183
USPC 138/177; 264/537; 425/533

(57) ABSTRACT

A method that enables a thermoplastic pipe in a partial or complete bellows-form, preferably having connecting elements such as clip, bracket, etc. thereon to be manufactured in a single process.

The present invention relates to a method that enables a thermoplastic pipe in a partial or complete bellows-form, preferably having connecting elements such as clip, bracket, etc. thereon to be manufactured in a single process.

### PRIOR ART

Gas/water/projectile injection techniques are manufacturing methods that are used to manufacture a hollow article by injecting a molten plastic into a mold cavity and, thanks to the faster cooling and solidification of the outer walls of the melt, forcing the not-yet solidified material in the core out of the mold by means of pressurized gas (GIT), liquid (LIT), especially water (WIT) and projectile (PIT).

Plastic molding technique by means of gas injection technology is known for a long time. In the U.S. Pat. No. 4,923,667 published in 1990, it is disclosed that hollow articles can be manufactured by supplying gas into the mold cavity filled with molten plastic.

In the Patent No. DE 19903682, it is disclosed that a liquid, especially water can be used instead of gas in order to push the molten core out of the mold cavity. A faster process is achieved as the water absorbs more heat compared to gas. In the Patent No. WO 2004113048, it is disclosed that water injection technique allows manufacturing of pipes with thinner walls in comparison to the gas injection technique. Moreover, the hesitation marks, which are surface defects causing quality problems and occurring due to the high viscosity difference between the melt material and the gas, can be eliminated by using water instead of gas.

A significant advantage of gas/water/projectile injection technology is that with this method, connecting elements like clips, brackets, etc. desired to be present on the pipe can be formed as a single piece together with the product during the injection process and thus no additional joining step is needed.

Pipes and hoses manufactured with gas/water/projectile injection technology are used especially in automotive industry in sections like engine cooling systems, radiators, fuel systems, etc. and manufactured from various thermoplastic materials, generally from fiberglass reinforced polyamide. As disclosed in the Patent Application No. US 2010294421, in such systems, pipes connect hard-to-reach points in crowded engine compartments and are exposed to a severe vibration. A bellows form that is at least regionally formed on the pipe provides a significant advantage for absorbing said vibration as well as maintaining the elasticity required for an easy installation. However, with the gas/water/projectile injection technologies, it is not possible to obtain a bellows form on a pipe of such type. Although manufacturing of a hose in bellows form with the water injection technology is disclosed in the patent application no. DE 102005033172, said hose is manufactured from a thermoplastic elastomer material and used as a sheath for protecting cables that connects the doors, tailgates and similar movable parts of motor vehicles to the vehicle body. Although it is not possible to obtain a precise inner bellows structure with the method disclosed in DE 102005033172, the product still gains a sufficient elasticity thanks to the thermoplastic elastomer material used. However, in the cooling, fuel and turbocharger systems of motor vehicles wherein the method of the present invention will be used, connecting elements that should be provided on the pipe cannot be manufactured from a thermoplastic elastomer material due to the heat resistance and mechanical strength requirements. Therefore, secondary processes will be needed for joining the connecting elements to a bellows pipe manufactured with the method disclosed in the above mentioned patent.

In the patent application no. WO 0168397, a method is disclosed for manufacturing a fuel filler pipe with a rigid and smooth portion in the middle region and a bellows portion close to an end. In this method, the plastic melt injected into the mold cavity is blown towards the walls of the mold by means of a pressurized gas. Although a bellows pipe can be manufactured with such a blow molding method, connecting elements required on the pipe cannot be manufactured and secondary processes such as welding or overmolding are needed for the elements of this type. Such secondary joining processes cause extra cost and operation time and also increase leakage possibility at welding regions.

### SHORT DESCRIPTION OF THE INVENTION

In the present invention, a method is disclosed which enables the manufacturing of a bellows pipe that can be used in crowded engine compartments, can be easily detached and attached, and that can absorb the vibrations generated by the engine, by using fluid/projectile injection technologies.

A method enabling the manufacturing of a bellows pipe with fluid/projectile injection technologies will reduce the process time by decreasing the number of manufacturing steps, will provide an easy and simple manufacturing process and decrease the manufacturing costs.

In the first stage of the method of the present invention, the mold cavity is filled with the molten material. In this stage, a smooth slider set is present at the region of the mold that will provide the bellows form. Following the injection, the molten material in the mold cavity starts cooling first on its outer surfaces. The relatively hotter and liquid material remaining in the core is displaced from the mold cavity by means of a pressurized fluid or a projectile injected into the mold cavity. As a result of the first stage of the method, a preform without bellows is obtained. In the following stage, the smooth slider set is moved away and a second slider set which is orthogonal to the former one and which has bellows-shaped inner walls is moved in the emptied space of the former one.

Before this change, the pressure in the preform is equalized to the atmospheric pressure. Finally, by again supplying pressurized fluid into the mold cavity, the preform that is still hot is blown up to stick to the walls and thus the desired bellows form is obtained.

The present invention will be described in detail by means of the figures.

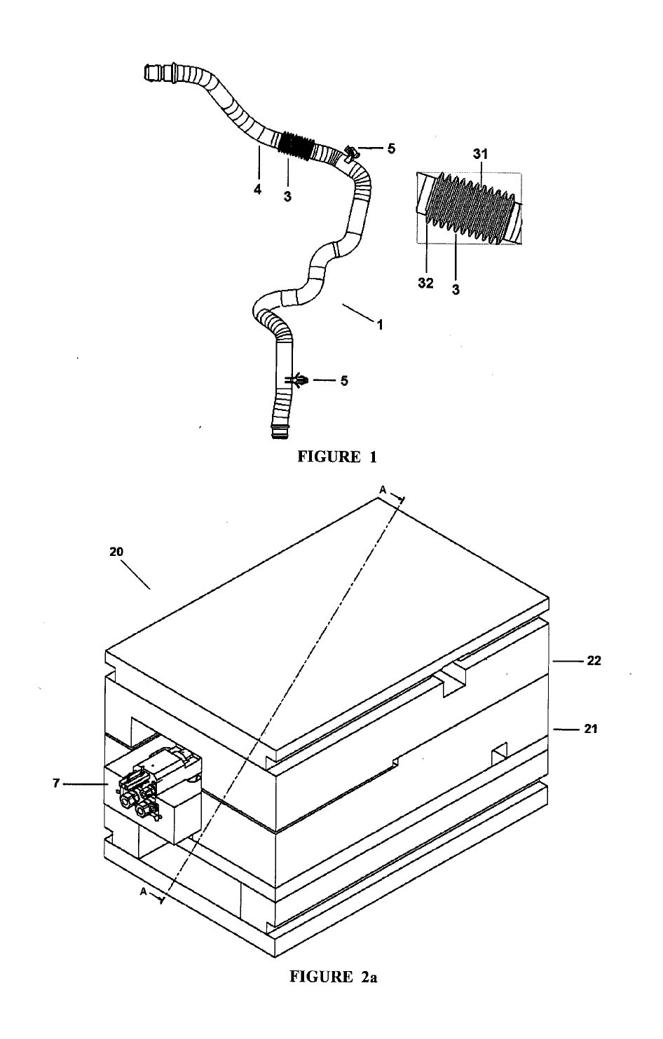

FIG. 1 shows the bellows pipe manufactured with the method of the present invention.

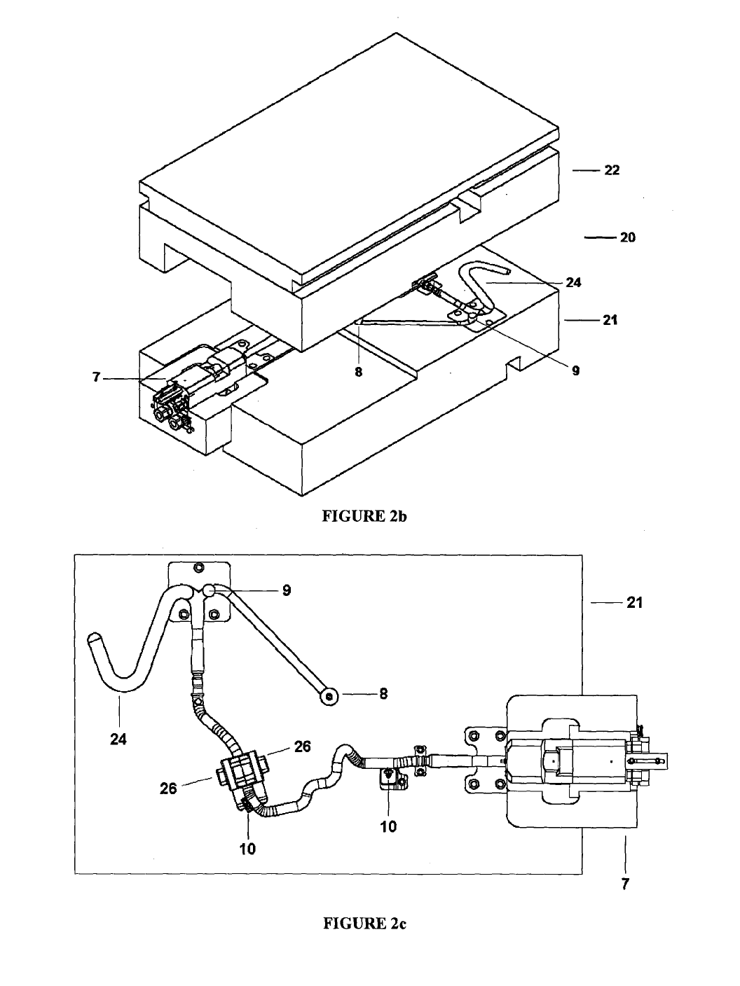

FIG. 2a is the isometric view of the mold used for the manufacturing of the pipe.

FIG. 2b is the isometric view of the halves of the mold

FIG. 2c is the simplified top view of the male mold portion.

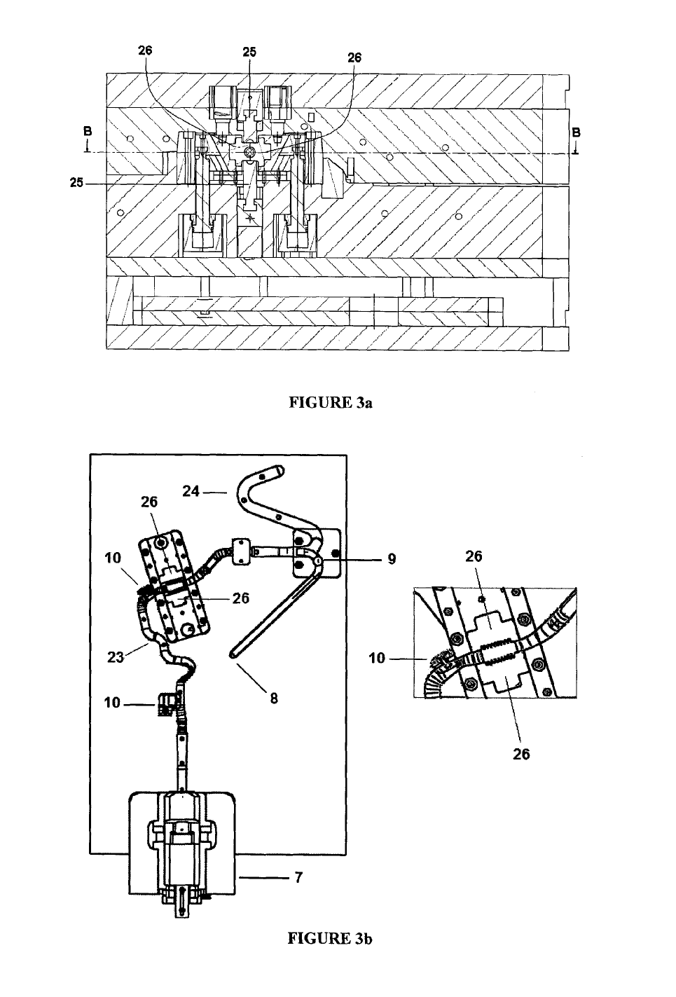

FIG. 3a is the cross-sectional view of the mold in FIG. 2a with respect to A-A

FIG. 3b is the cross-sectional view of the mold in FIG. 2a with respect to B-B

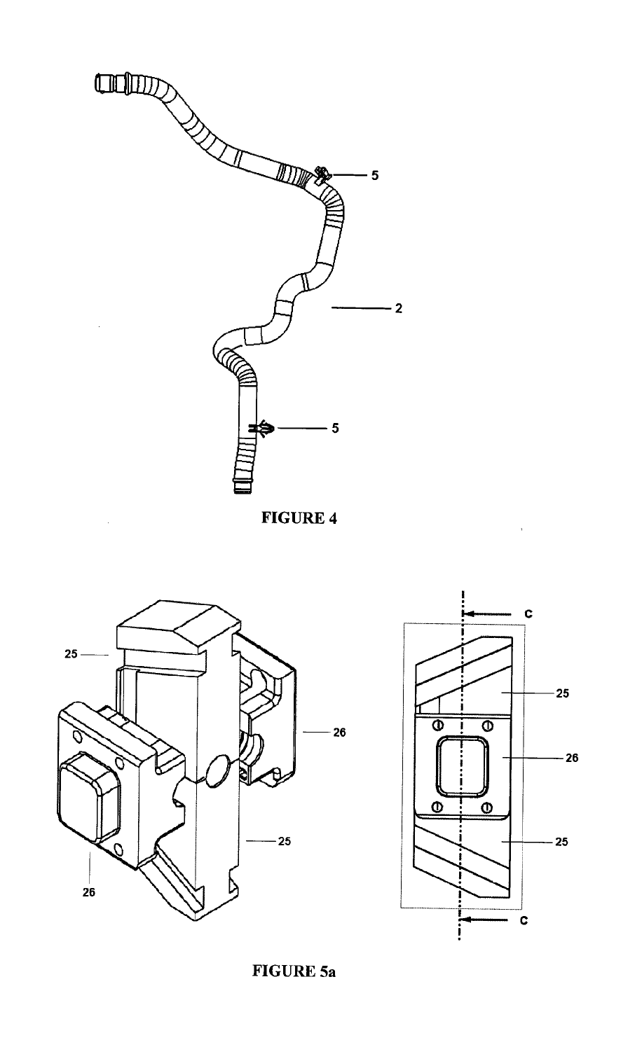

FIG. 4 is the view of the smooth preform obtained in the first stage of the method.

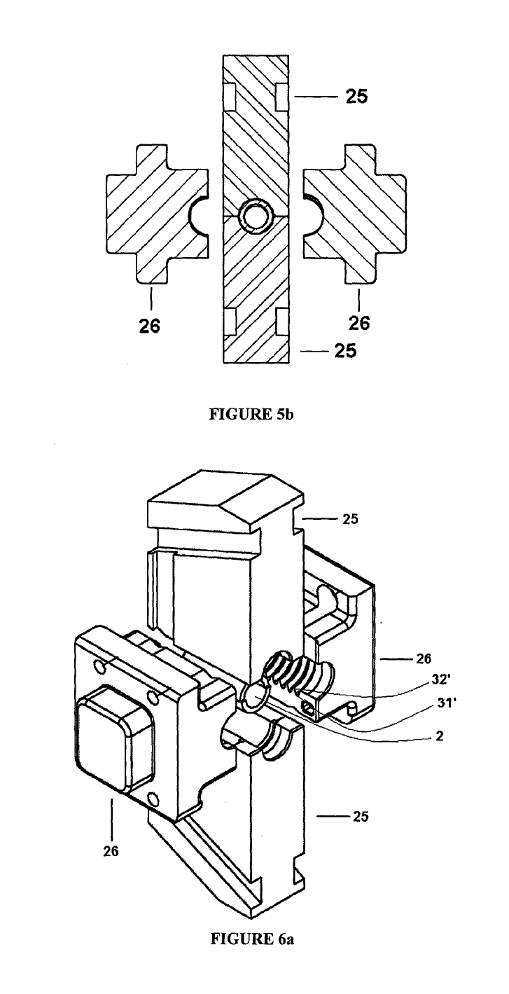

FIG. 5a is the isometric and sideways view of the slider sets in the first stage of the method.

FIG. 5b is the cross-sectional view of the mold in FIG. 5a with respect to C-C line.

FIG. 6a is the isometric view of the slider sets during the replacement process.

FIG. 6b is the cross-sectional view of the slider sets during the replacement process.

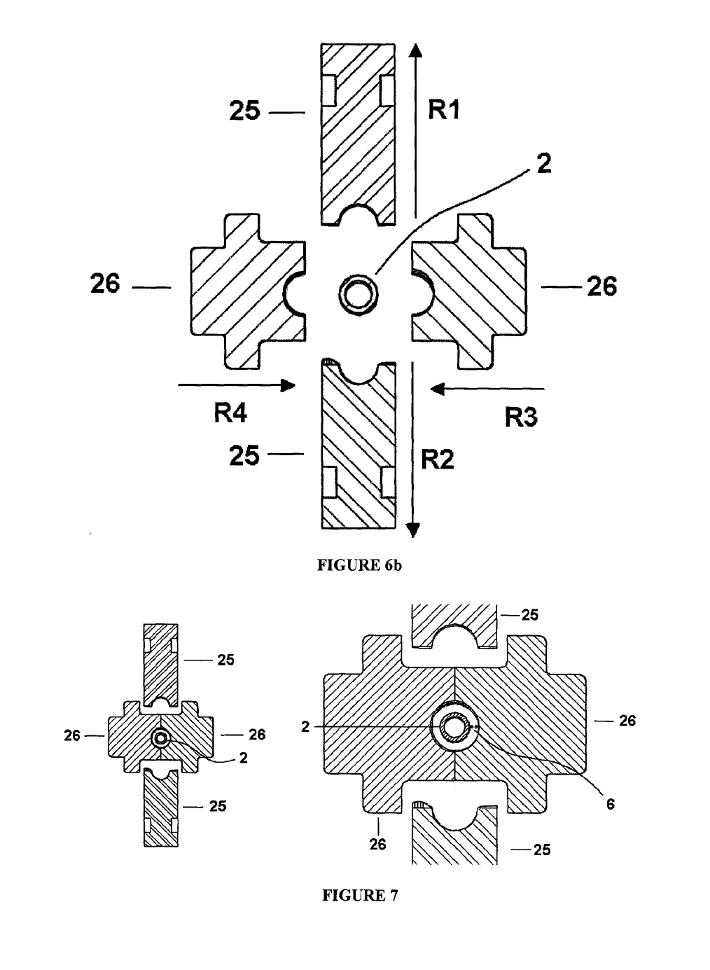

FIG. 7 is the cross-sectional view of the slider sets in FIG. 5b before the second stage of the method.

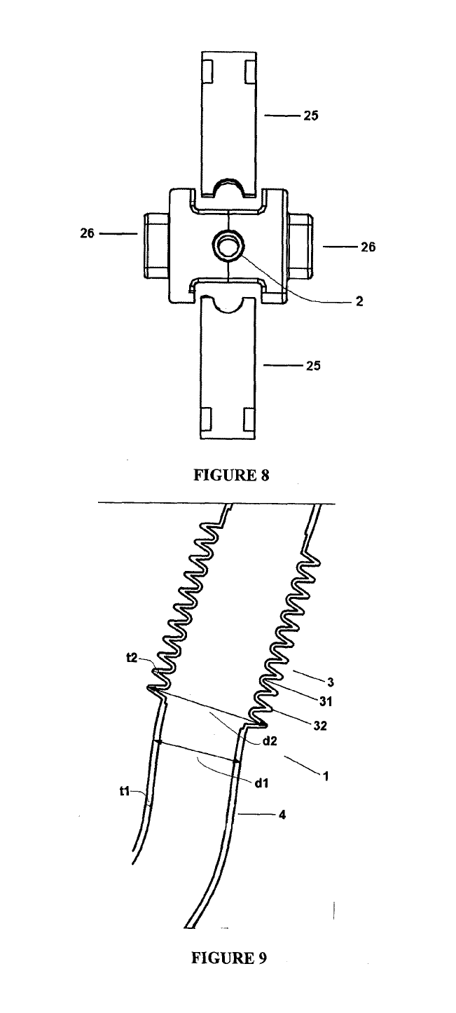

FIG. 8 is the front view of the slider sets after the second stage of the method.

FIG. 9 is the cross-sectional view of the bellows portion of the pipe.

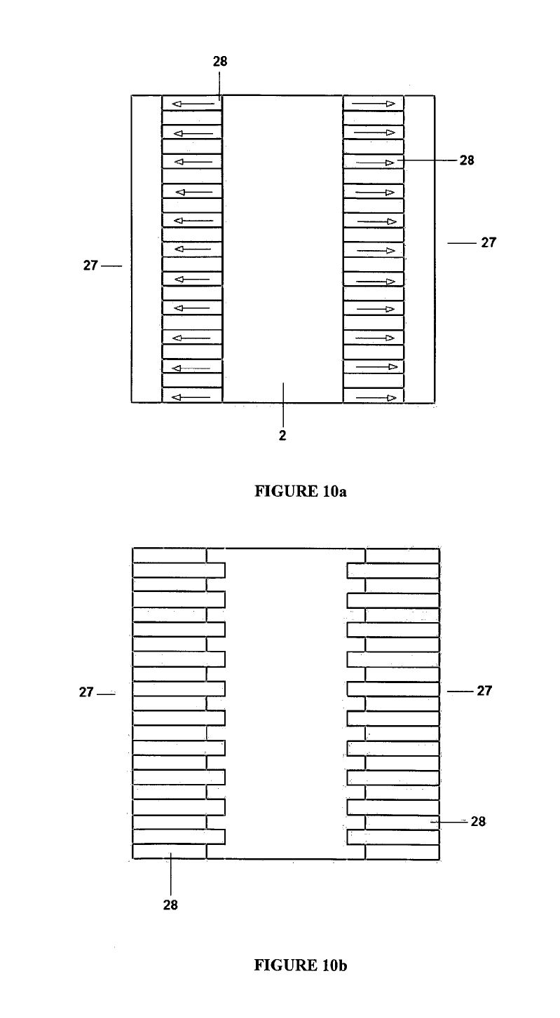

FIG. 10a is the view of the stationary slider set used in the method when the segments are closed.

FIG. 10b is the view of the stationary slider set used in the method when the segments are open.

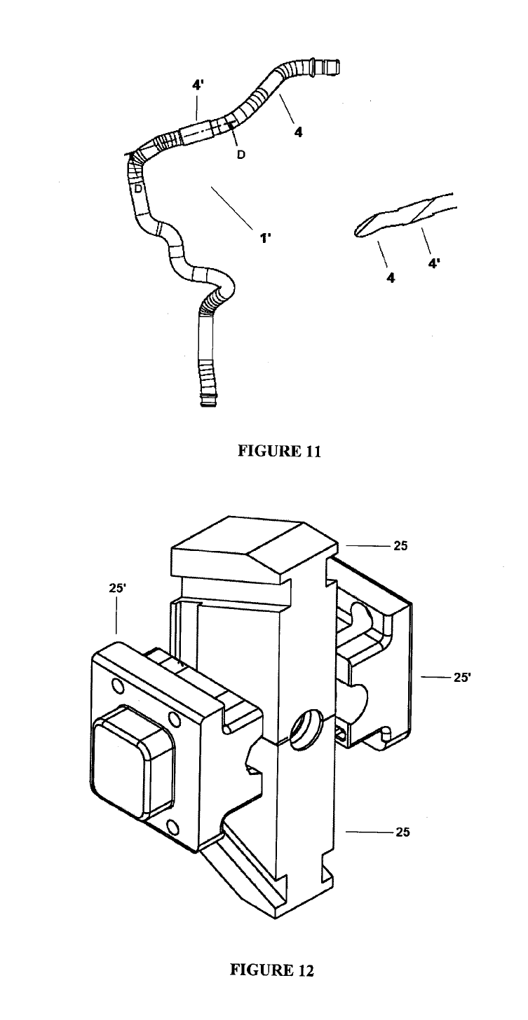

FIG. 11 shows the smooth pipe having portions with equal wall thicknesses and different cross-sections, obtained with the method of the present invention.

FIG. 12 is the isometric view of the slider sets used in the manufacturing of the pipe having portions with different cross-sections in equal wall thicknesses.

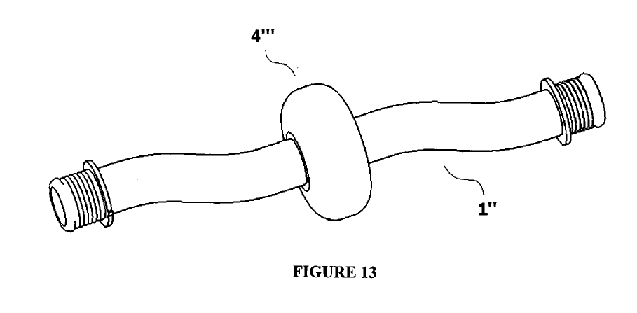

FIG. 13 shows a pipe manufactured with the method of the present invention.

The elements related to the present invention are numbered as follows in the above-described figures:
1 Bellows pipe
1′, 1″ Smooth pipe with enlarged sections
2 Preform without bellows
3 Bellows portion
4 Smooth tubular portion
4′, 4″ Large diameter smooth portion
5 Connecting elements
6 Space
7 Injector
8 Nozzle
9 Valve
10 Portion
20 Mold
21 Male mold
22 Female mold
23 Mold cavity
24 Extra mold cavity
25 Smooth slider set
25′ Smooth slider set
26 Corrugated slider set
27 Stationary slider set
28 Segment
31 Trough
32 Ridge
31′ Trough
32′ Ridge
t1 Wall thickness of smooth portion
t2 Wall thickness of bellows portion
d1 Outer diameter of smooth portion
d2 Outer diameter of bellows portion

### DETAILED DESCRIPTION OF THE INVENTION

FIG. 1 shows a pipe (1) manufactured with the method of the present invention. The pipe (1) is composed of a bellows portion (3) comprising ridges (32) and troughs (31), and a remaining smooth tubular portion (4). Besides the bellows and the smooth portions (3,4), various connecting elements (5) are provided on the pipe (1) to be used in the engine circuit wherein the pipe (1) will be placed. By means of the said method, said connecting elements (5) are manufactured without applying any additional process such as welding or overmolding.

The number of the troughs (31) and ridges (32) on the bellows portion (3) may change according to the application area of the product (1). The depths of the troughs and ridges (31, 32) may also be changed in accordance with the ambient conditions as well as the pipe material. The bellows portion (3) can be formed at any region of the pipe (1), or even the whole pipe (1) can be manufactured in bellows form.

As shown in FIG. 2a-2c, the mold (20) used in the manufacturing of the pipe (1) is composed of two halves, being a male half (21) and a female half (22). When the two halves (21,22) are assembled, a mold cavity (23) having the form that is desired to be applied to the pipe (1) is obtained. The mold cavity (23), seen in detail in FIG. 3b, starts from the nozzle (8) through which the melt is injected, passes through the part where the sliders (26) are disposed to form the bellows portion and continues up to the injector (7) from which the pressurized fluid is injected. Moreover, the mold cavity (23) branches off to form an extra mold cavity (24) into which the displaced molten plastic will fill. Said extra mold cavity (24) is kept in isolated position during the injection of the melt by means of a valve (9). At the moment the pressurized fluid or the projectile is injected into the mold (20) to form the hollow, said valve (9) is opened, thus enabling the expelled material to fill into the extra mold cavity (24). At one end of the mold cavity (23) there is the nozzle (8) through which the molten plastic is supplied, and at the other end there is the injector (7) through which the pressurized fluid or the projectile is injected. Moreover, the mold cavity (23) comprises portions (10) that will form the required connecting elements (5) on the pipe (1).

At some part of the mold cavity (23), the two slider sets (25, 26) oriented orthogonal to each other as in FIG. 5a, are provided. In the first stage of the method, the slider set (25) with smooth inner walls is used. On the other hand, the corrugated slider set (26) used in the second stage of the method has the bellows shape which is intended to be given to the pipe (1) with the troughs (31′) and the ridges (32′) formed on its inner walls. Said two slider sets (25, 26) are positioned at the region in the mold (20) where the bellows portion (3) will be formed. The angle between slider sets (25, 26) and the mold cavity (23) can be altered.

In the first stage of the process, the melt injected through the nozzle (8) fills in the whole mold cavity (23) except the extra mold cavity (24) since the valve (9) is closed. After the mold cavity (23) is filled, the valve (9) connected to the extra mold cavity (24) is opened. As the outer surfaces of the molten plastic filling the mold cavity (23) starts cooling, a pressurized fluid, preferably water is injected through the injector (7). On one hand the pressurized fluid accelerates the cooling of the melt, on the other hand it pushes the hot and liquid material in the core out of the mold cavity (23). The displaced plastic material fills in the extra mold cavity (24). In this process, the molten core can also be expelled by injecting a projectile instead of pressurized fluid.

FIG. 4 shows the hollow smooth preform (2) with the connecting elements (5) which is obtained in the first stage of the method as a result of the above-mentioned operations.

FIG. 5 shows the position of the slider sets (25, 26) as the molten plastic is injected in the first stage of the method. In this stage, the smooth slider set (25) is closed and forming the part of the mold cavity (23). On the other hand, the corrugated slider set (26) is open and orthogonal to the smooth slider set (25). After the smooth preform (2) is formed, the smooth slider set (25) is detached by being moved in opposite directions (R1, R2) as shown in FIG. 6b. The corrugated slider set (26) perpendicular to the smooth sliders (25) is moved in the direction of arrows (R3, R4) and placed onto the preform (2). As shown in FIG. 7, a space (6) remains between the sliders (26) and the preform (2). The amount of this space (6) determines the wall thickness difference between the bellows portion (3) and the smooth tubular portion (4).

In order to prevent undesired deformations during the replacement of the sliders (25, 26), the pressure inside the preform (2) which is not entirely cold and stiff yet is equalized to the atmospheric pressure before any replacement of the sliders (25, 26).

After the corrugated slider set (26) is attached, the pressurized fluid is once again supplied into the preform (2). The plastic material which is still in half-molten state is blown by the pressure to stick to the bellows shaped walls of the slider (26) so that it takes the intended bellows form (3).

FIG. 8 shows the preform (2) that is inflated by the pressurized fluid and takes the bellows shape of the corrugated sliders (26). The space (6) between the preform and the slider set (26) is now closed.

The bellows portion (3) is obtained by means of the troughs and ridges (31, 32) formed at both the inner and outer surfaces of the pipe (1) by means of the blowing method with pressurized fluid applied in the second stage of the method. The outer diameter (d2) of the bellows portion (3) is larger than the outer diameter (d1) of the smooth tubular portion (4). By leaving a space (6) between the corrugated slider set (26) and the preform (2), the bellows portion (3) is inflated, and while its outer diameter (d2) increases, its wall thickness (t2) decreases. Thus, the bellows portion (3) the walls of which are thinner with respect to the walls of the smooth tubular portion (4) gives the desired elasticity to the pipe (1). The said difference of wall thicknesses may change in accordance with the volume of the space (6) between the slider set (26) and the preform (2). Moreover, the slider sets (25, 26) can be heated or cooled in order to obtain a much better bellows form (3).

The replacement of the sliders (25, 26) between the first stage and the second stage of the method is not limited to the displacement and replacement of the first and second slider sets (25, 26). FIG. 10a shows a stationary slider set (27) used in the first stage of the method. The movable segments (28) on the stationary slider set (27) move away from the preform (2) and retract in the second stage of the method as shown in FIG. 10b. The pressurized fluid applied in the second stage of the method inflates the preform (2) towards the gaps formed after the retraction of the segments (28), thus providing the final form. The bellows structure can be also formed by the movable segments (28) moving forward in the second stage of the method.

The slider (25, 26) replacement operations performed in the said inflation method realized by using fluid/projectile technologies can be diversified beyond the examples given herein. For example, each of the smooth and figured slider sets (25, 26) can be composed of three or more pieces instead of two halves. Alternatively, a bellows form (3) covering a certain angle can be formed on the pipe (1) instead of an all-around, 360° form. In this case, rather than using slider sets (25, 26), a single movable smooth slider and a single movable corrugated slider can be used at the region where the figure will be formed.

The disclosed method used for manufacturing bellows pipes can also be used for manufacturing a variable diameter pipe with a substantially uniform wall thickness distribution. As is known, the thinnest wall thickness that can be obtained by the pressurized fluid injection technologies proportionately changes with the outer diameter of the pipe. For this reason, a pipe manufactured with the pressurized fluid injection technologies must have different wall thicknesses at different diameter sections. Thus, s pipe (1″) depicted in FIG. 13, which has a larger diameter section (4″) for sound absorbing purposes for example, can be manufactured by joining three separately manufactured sections by welding. Due to a great number of operations and extra labor required by this method, manufacturing costs and quality risks increase. However, by means of the manufacturing method of the present invention, a resonator pipe of this type can be manufactured in a single process.

Besides variations in diameters, it is frequently encountered, especially in automotive fluid lines, that the pipe cross-section is not circular at certain regions. In the above-mentioned conventional pressurized fluid injection technologies, the hollow section emptied by the pressurized fluid cannot follow the changing outer cross-section of the pipe due to the nature of the process. For this reason, for example although the pipe starting with a circular cross-section becomes elliptic at its middle portion, the inner volume emptied by the fluid maintains its circular structure. As a result of this, wall thickness of the pipe gets dangerously narrow along the long side of the elliptic cross-section, while being improperly thicker along the short side. By means of the manufacturing method of the present invention, pipes of this type having a cross-section varying regionally can also be manufactured in a single process with relatively uniform wall thickness distribution.

FIG. 11 shows a pipe (1′) comprising a smooth portion (4′) with a larger diameter with respect to the rest of the pipe (1′), manufactured with fluid injection methods and having a uniform wall thicknesses distribution. In the first stage of the manufacturing method of this pipe (1′), the smooth slider set (25) that is active in the mold (20) defines a constant diameter cavity (23). The core of the molten plastic filling the cavity (23) is pushed out by the pressurized fluid supplied into the melt. In this manner, a preform (2) with a given wall thickness is obtained. Then, another smooth slider set (25′) which is orthogonal to the former one (25) is attached to the mold in such a manner that a space (6) remains between the slider set (25′) and the preform (2). Said sliders (25, 25′) are shown in FIG. 12.

In the second stage of the method, the preform (2) is blown towards the walls of the slider (25′) by means of the pressurize fluid, but this time, a smooth but larger diameter section (4′) is formed on the pipe (1′) instead of a bellows portion (3).

Even if the final wall thickness of the large diameter smooth portion (4′) is thinner with respect to the rest of the pipe (1′), this difference is much smaller than the wall thickness difference than can be obtained with the state of the art methods. In this manner, manufacturing of a pipe with changing cross-section but uniform wall thickness is made possible by means of fluid injection techniques. Similarly, in order to diversify pipe forms that can be obtained by means of the method of the present invention, sliders in different forms other than corrugated or smooth can be used. Moreover, the number of the slider sets, the number of the sliders in the sets, the positions and angles of the sliders with respect to each other and to the mold, and the shapes and the inner wall forms of the sliders can also be altered according to the characteristics of the pipe to be manufactured and the manufacturing resources.

Alternatively, the manufacturing method of the present invention can also be used for manufacturing products with smaller or larger wall thicknesses at the region where the cross-section is different.

The method of the present invention can be used for shaping polypropylene (PP), polyethylene (PE) or similar polyolefins or engineering plastics such as polybutylene terephthalate (PBT), thermoplastic elastomer (TPE), polyphenylene sulfide (PPS) or nylon. Moreover, said method is also suitable for shaping pipes manufactured from multi-layered or successively-different materials.

The disclosed method of manufacturing enables the attachments like clips, clamps, brackets etc that are conventionally manufactured in a separate step and then joined with the pipe by a welding operation, to be manufactured together with the product in a single operation.

1. A manufacturing method for manufacturing a hollow plastic article (1), having partially or completely a bellows form, characterized in that the said method comprises the steps of
a) injecting a molten plastic material into a mold cavity (23) with no bellows form,
b) pushing the core of the molten material out by injecting a pressurized fluid or a projectile into the material and thus obtaining a hollow preform (2) with no bellows,
c) activating the sliders (26) on the mold (20), that will provide the bellows form, by means of a movable slider system positioned in the mold (20) at a region where the bellows portion (3) will be formed,
d) inflating the not-entirely-solidified material towards the walls of the mold by supplying high-pressure gas and/or liquid into the preform (2) and thus forming the bellows shape (3),
e) discharging the fluid after the plastic material completely solidifies, and then removing the final article (1) with bellows form from the mold (20).

2. A manufacturing method as in claim 1, wherein the mold cavity (23) in step (a) is formed in a mold (20) having two halves being the male (21) and the female (22), and at one end of which there is a nozzle (8) through which the molten plastic is supplied and at the other end there is an injector (7) through which the pressurized fluid or the projectile is injected.

3. A manufacturing method as in claim 1, wherein at one end of the said mold cavity (23) in the step (a), an extra mold cavity (24) is provided, into which the molten material displaced in step (b) fills.

4. A manufacturing method as in claim 3, wherein said extra mold cavity (24) is connected to the said mold cavity (23) by means of a valve (9) that is closed during step (a) and opened during step (b).

5. A manufacturing method as in claim 1, wherein said mold cavity (23) in step (a) comprises additional portions (10) that will form the required connecting elements (5) on the plastic article (1).

6. A manufacturing method as in claim 1, wherein said pressurized fluid in step (b) is water.

7. A manufacturing method as in claim 1, wherein said pressurized fluid in step (b) is gas.

8. A manufacturing method as in claim 1, wherein said movable slider system in step (c) is composed of two slider sets (25, 26).

9. A manufacturing method as in claim 8, wherein one (25) of the said two slider sets (25, 26) has a smooth inner wall, while the other one (26) has a bellows form that is desired to be formed on the final product (1) with troughs (31′) and ridges (32′).

10. A manufacturing method as in claim 9, wherein said two slider sets (25, 26) are arranged orthogonal to each other.

11. A manufacturing method as in claim 10, wherein in steps (a) and (b), said smooth slider set (25) is in closed state to form the mold cavity, whereas the corrugated slider set (26) is in detached position; in step (c) the smooth slider set (25) is detached by moving in opposite directions (R1, R2) and the corrugated slider set (26) is closed by moving towards each other (R3, R4) to form the mold cavity; and in steps (d) and (e) take place while the corrugated slider set (26) is closed, and the smooth slider set (25) is in detached position.

12. A manufacturing method as in claim 11, wherein there is a certain space (6) between the inner diameter of said corrugated slider set (26) in closed position and the outer diameter of the preform (2).

13. A manufacturing method as in claim 12, wherein the outer diameter (d2) of the bellows portion (3) is larger than the outer diameter (d1) of the smooth tubular portion (4) and the wall thickness (t2) of the former is smaller than the wall thickness (t1) of the latter.

14. A manufacturing method as in claim 1, wherein said method comprises an additional step of equalizing the pressure inside the preform (2) to the atmospheric pressure between the steps (b) and (c).

15. A manufacturing method as in claim 1, wherein one or both of the slider sets (25, 26) are heated or cooled in order to give a better bellows form (3).

16. A manufacturing method as in claim 1, wherein the said movable slider system in step (c) is composed of movable segments (28) on a stationary slider set (27).

17. A hollow plastic article (1) manufactured according to claim 1.

18. A manufacturing method as in claim 1, wherein said plastic article (1) is a pipe.

19. A manufacturing method used for manufacturing a hollow plastic article (1′) with a changing cross-section and substantially uniform wall thickness, characterized in that the said manufacturing method comprises the steps of
a) injecting a molten plastic material into a mold cavity (23) with a constant diameter,
b) displacing the core of the molten material by injecting a pressurized fluid or a projectile into the material and thus obtaining a hollow preform (2) with a uniform wall thickness, c) activating the sliders (25) on the mold (20), that will provide the alternative cross-section (4′), by means of a movable slider system positioned in the mold (20) at the region where the portion with that alternative cross-section (4′) will be formed,
d) inflating the not-entirely-solidified material towards the walls of the mold (20) by supplying high-pressure gas and/or liquid into the perform (2) and thus forming the portion with a different cross-section (4′),
e) discharging the fluid after the plastic material completely solidifies and then removing the final article (V) with changing cross-section but uniform wall thickness from the mold (20).

20. A manufacturing method as in claim 19, wherein the said plastic article (1′) is a pipe.

21. A manufacturing method as in claim 19, wherein said plastic article (1″) is a pipe having a larger diameter section (4″) for sound absorption purposes.

22. A hollow plastic article (1′) manufactured according to claim 19.

23. A hollow plastic article (1″) manufactured according to claim 21.

24. An apparatus characterized by comprising a mold (20) that is used for manufacturing a hollow plastic article (1) having partially or completely a bellows form, that has two halves as the male (21) and the female (22) and that comprises a smooth mold cavity (23), at one end of which there is a nozzle (8) through which the molten plastic is injected and at the other end there is an injector (7) through which the pressurized liquid or the projectile is injected and also comprises a movable slider system (25, 26) that will provide the bellows form.

25. An apparatus as in claim 24, wherein at one end of the said mold cavity (23) an extra mold cavity (24) is provided, into which the molten material displaced in step (b) fills.

26. An apparatus as in claim 25, wherein said extra mold cavity (24) is connected to the said mold cavity (23) by means of a valve (9).

27. An apparatus as in claim 24, wherein the said mold cavity (23) comprises additional portions(10) that will form the required connecting elements (5) on the plastic article(1).

28. A manufacturing apparatus as in claim 24, wherein the said movable slider system is composed of two slider sets (25, 26).

29. An apparatus as in claim 28, wherein one (25) of the said two slider sets (25, 26) has smooth inner wall while the other (26) one has a bellows form that is desired to be formed on the final product (1) with troughs (31′) and ridges (32′).

30. An apparatus as in claim 29, wherein between the inner diameter of said corrugated slider set (26) and said smooth slider set (25), there is a space (6) determining the wall thickness difference between the bellows form (3) and the smooth tubular form (4) of the final product (1).

31. An apparatus as in claim 28, wherein said two slider sets (25, 26) are arranged orthogonal to each other.

32. An apparatus as in claim 28, wherein one or both of said slider sets (25, 26) are heated or cooled in order to give a better bellows form (3).

33. An apparatus as in claim 24, characterized in that the said movable slider system is composed of the movable segments (28) on the stationary slider set (27).
